(19) United States
(12) Patent Application Publication
(10) Pub. No.: US 2022/0242162 A1
(43) Pub. Date: Aug. 4, 2022

(54) COVER ASSEMBLY FOR FLUID-HOLDING VESSEL

(71) Applicant: Clean Can Solutions, LLC, Norton Shores, MI (US)

(72) Inventor: David Fegel, Norton Shores, MI (US)

(21) Appl. No.: 17/588,905

(22) Filed: Jan. 31, 2022

Related U.S. Application Data
(60) Provisional application No. 63/144,282, filed on Feb. 1, 2021.

(51) Int. Cl. B44D 3/12

(52) U.S. Cl. CPC B44D 3/127

(57) ABSTRACT

A cover assembly includes a first portion and a second portion.

### CROSS-REFERENCE TO RELATED APPLICATION

This application claims priority to and the benefit under 35 U.S.C. § 119(e) of U.S. Provisional Patent Application No. 63/144,282, filed on Feb. 1, 2021, entitled COVER ASSEMBLY FOR FLUID-HOLDING VESSEL, the entire disclosure of which is hereby incorporated herein by reference.

### FIELD OF THE DISCLOSURE

The present disclosure generally relates to a cover assembly. More specifically, the present disclosure relates to a cover assembly for a fluid-holding vessel.

### BACKGROUND OF THE INVENTION

Fluid-holding vessels, such as paint cans, are typically provided with a lid upon purchase. However, during normal use, issues can arise that result in user difficulty relating to repeated opening and closing of the fluid-holding vessel. Therefore, additional solutions are needed that improve user experience with fluid-holding vessels.

### SUMMARY OF THE INVENTION

According to a first aspect of the present invention, a cover assembly includes a first portion. The first portion includes a planar region and a tab. The planar region defines an aperture. The tab extends downwardly from the planar region and is configured to be received within a reservoir of a fluid-holding vessel.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a front perspective view of a prior art fluid-holding vessel, according to one example;

FIG. 2 is a front perspective view of the prior art fluid-holding vessel, illustrating a rim structure, according to one example;

FIG. 3 is a top perspective view of a cover assembly, illustrating a first portion and a second portion separated from one another, according to one example;

FIG. 4 is a bottom perspective view of the cover assembly, illustrating the first portion and the second portion separated from one another;

FIG. 5 is a side perspective view of the cover assembly, illustrating the second portion resting upon the first portion;

FIG. 6 is a bottom perspective view of the first portion, illustrating a tab, a lip, and a ledge, according to one example;

FIG. 7 is a cross-sectional view of the first portion, taken along line VII-VII of FIG. 3, illustrating various components of the first portion, according to one example;

FIG. 8 is a cross-sectional view of the second portion, taken along line VII-VIII of FIG. 3, illustrating various components of the second portion, according to one example;

FIG. 9 is a cross-sectional view of the cover assembly, taken along line IX-IX of FIG. 5, with the fluid-holding vessel in dashed lines and illustrating the interaction between the first portion, the second portion, and the fluid-holding vessel, according to one example;

FIG. 10A is a schematic radial cross-sectional representation of the first portion, according to an alternative example;

FIG. 10B is a schematic radial cross-sectional representation of the first portion, according to another alternative example;

FIG. 11 is a schematic radial cross-sectional representation of the first portion, according to an alternative example;

FIG. 12 is a schematic radial cross-sectional representation of the first portion, according to one alternative example;

FIG. 13 is a schematic radial cross-sectional representation of the first portion, according to another alternative example;

FIG. 14 is a schematic diametric cross-sectional representation of the first portion, according to one alternative example; and

FIG. 15 is a schematic diametric cross-sectional representation of the first portion, according to an alternative example.

### DETAILED DESCRIPTION OF THE PREFERRED EMBODIMENTS

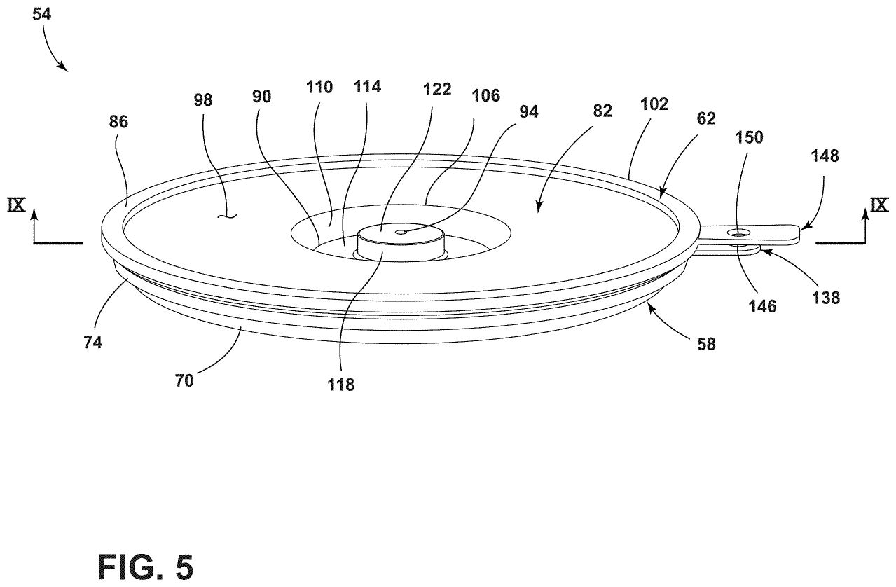

For purposes of description herein, the terms “upper,” “lower,” “right,” “left,” “rear,” “front,” “vertical,” “horizontal,” and derivatives thereof shall relate to the concepts as oriented in FIG. 5. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a cover assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

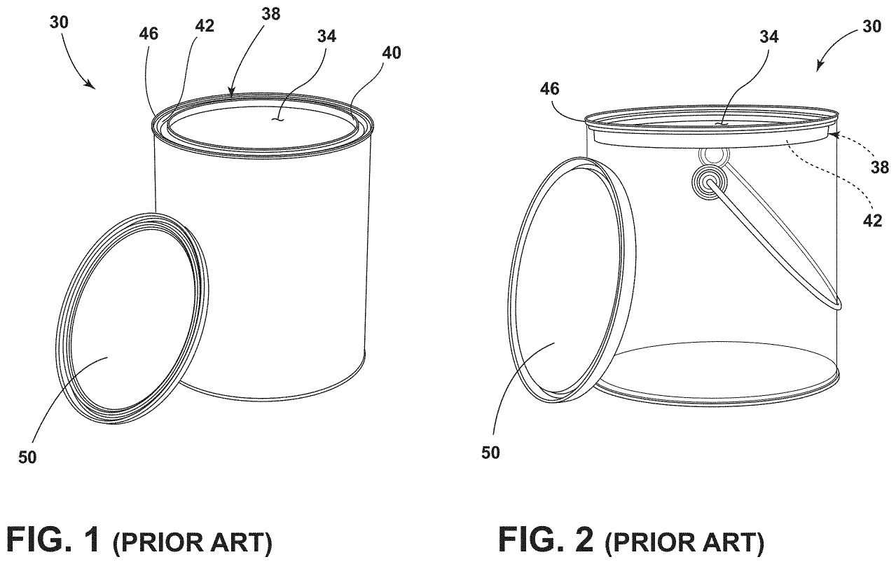

Referring to FIGS. 1 and 2, reference numeral 30 generally designates a prior art fluid-holding vessel. In various examples, the fluid-holding vessel 30 may be a paint can. The fluid-holding vessel 30 defines an opening 34, through which fluid stored within the fluid-holding vessel 30 may be accessed. The fluid-holding vessel 30 includes a rim structure 38 that defines a reservoir 42 and a channel 46. An inner surface 40 of the rim structure 38 can define the opening 34. The opening 34 of the fluid-holding vessel 30 may be provided with a lid 50 when purchased, where the lid 50 initially covers the opening 34 and engages the reservoir 42 and the channel 46 to secure the lid 50 in place.

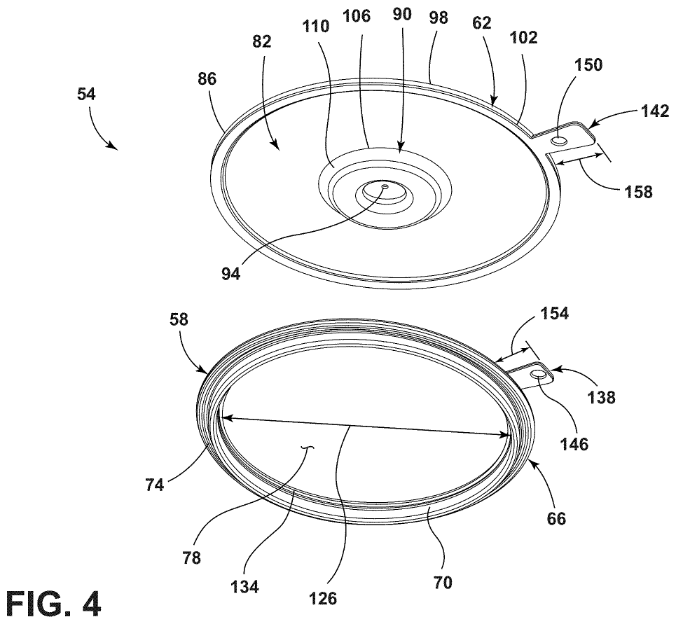

Referring now to FIGS. 1-4, a cover assembly 54 is disclosed that can be positioned upon the fluid-holding vessel 30 such that the opening 34 that is defined by the fluid-holding vessel 30 is covered. The cover assembly 54 includes a first portion 58 and a second portion 62. The first portion 58 includes a planar region 66, a tab 70, and a lip 74. The planar region 66 defines an aperture 78. The tab 70 extends downwardly from the planar region 66 and is configured to be received within the reservoir 42 of the fluid-holding vessel 30. The lip 74 extends downwardly from the planar region 66. The lip 74 is positioned radially outward from the tab 70 on the planar region 66. In various examples, the tab 70 and the lip 74 may be provided with different heights and/or widths, as will be discussed further herein.

Referring again to FIGS. 1-4, the second portion 62 includes a body 82, a ridge 86, a recess 90, and a protrusion 94. The body 82 includes a top surface 98. The ridge 86 extends upwardly from the top surface 98 and is positioned proximate to a perimeter 102 of the second portion 62. The recess 90 extends downwardly from the top surface 98 of the body 82 proximate to a central region 106 of the second portion 62 such that the recess 90 includes or defines a wall 110 and a bottom surface 114. The protrusion 94 extends upwardly from the bottom surface 114 of the recess 90 such that the protrusion 94 defines an outer surface 118 and an upper surface 122. The outer surface 118 of the protrusion 94 is positioned radially inward from the wall 110. The upper surface 122 can be coplanar with the top surface 98 of the body 82. That is, the upper surface 122 of the protrusion 94 and the top surface 98 of the body 82 can extend, exist, or otherwise be positioned on the same two-dimensional plane.

Referring further to FIGS. 1 and 2, the fluid-holding vessel 30 is depicted as what is commonly referred to as a paint can. While the depicted example of the fluid-holding vessel 30 may be commonly referred to as a paint can, paint is not the only fluid that can be contained within such a vessel or similar vessels. Rather, other fluids may be contained within the fluid-holding vessel 30 without departing from the concepts disclosed herein. For example, rather than paint, the fluid-holding vessel 30 may contain a wood stain, a liquid coating (e.g., urethane), an oil-based liquid, a sealer, a lacquer, a conditioner, a dye, a finish (e.g., wood finishes, polyurethane wood finishes, shellac finishes, etc.), and so on. Accordingly, while the present disclosure may reference paint as an illustrative example of the fluid contained within the fluid-holding vessel 30, one of skill in the art will recognize that other fluids, consumables, and/or materials may be contained within the fluid-holding vessel 30 without departing from the concepts disclosed herein.

When a user or consumer purchases paint that is housed within a paint can similar to that depicted as the fluid-holding vessel 30, the lid 50 is typically secured to the fluid-holding vessel 30 such that the lid 50 covers the opening 34. In securing the lid 50 to the fluid-holding vessel 30, the lid 50 can be received within the reservoir 42 and/or the channel 46 of the rim structure 38, thereby providing a seal to the contents of the fluid-holding vessel 30. Upon removing the lid 50 from the fluid-holding vessel 30, the user may typically pour at least a portion of the contents of the fluid-holding vessel 30 into an auxiliary container (e.g., a paint tray) in the course of performing a task or project involving the contents of the fluid-holding vessel 30. Additionally or alternatively, the user may directly access the contents of the fluid-holding vessel 30 for the task or project with a fluid applicator (e.g., a paint brush). In such an example, the user may drag a fluid-laden portion of the fluid applicator (e.g., bristles of the paint brush) against an interior side of the rim structure 38. In these and other similar instances, where the contents of the fluid-holding vessel 30 are poured or the fluid applicator is dragged against the rim structure 38, some of the contents of the fluid-holding vessel 30 (e.g., paint) typically enters into the reservoir 42 and/or the channel 46.

Referring again to FIGS. 1 and 2, when the task or project is complete or has reached a stopping point, the user will seek to replace the lid 50 over the opening 34 of the fluid-holding vessel 30. In an effort to reestablish a seal to the fluid-holding vessel 30 and prolong a shelf life of any remaining fluid contained within the fluid-holding vessel 30, the lid 50 is pressed and in some cases hammered back into the reservoir 42 and/or the channel 46. In the event that the fluid from within the fluid-holding vessel 30, such as paint, has entered into the reservoir 42 and/or the channel 46, reestablishing a seal between the fluid-holding vessel 30 and the lid 50 can be difficult and messy as the partially dried paint now occupies at least a portion of the reservoir 42 and/or the channel 46. Additionally, in the case of paint and other coating materials, the fluid contained within the reservoir 42 and/or the channel 46 will dry over time and partially adhere the lid 50 to the reservoir 42 and the channel 46. This adhesion can increase the difficulty of removing the lid 50 from the fluid-holding vessel 30 when the user desires to resume the task or project or generally access the contents of the fluid-holding vessel 30.

In examples where the contents of the fluid-holding vessel 30 are paint or other similar products, the fluid that has entered the reservoir 42 and/or the channel 46 typically acts as an adhering agent as the fluid within the reservoir 42 and/or the channel 46 dries and/or hardens. Accordingly, a user must overcome a compression-fit force between the lid 50 and the fluid-holding vessel 30, as well as an adhesive force between the fluid-holding vessel 30, the fluid from the fluid-holding vessel 30, and the lid 50. Even when the lid 50 is partially separated from the fluid-holding vessel 30, the dried paint typically has an elastic quality that can make it difficult to fully remove the lid 50 from the fluid-holding vessel 30. In addition to the user having to overcome the additional adhesive force, the presence of the fluid from the fluid-holding vessel 30 within the reservoir 42 and/or the channel 46 can result in a failure to reestablish a seal between the fluid-holding vessel 30 and the lid 50. Because the paint occupies at least a portion of the reservoir 42, the reservoir 42 can be unable to accommodate both the paint and the lid 50. With an incomplete seal between the lid 50 and the fluid-holding vessel 30, air can inter into the interior volume of the fluid-holding vessel 30 and dry or otherwise spoil the liquid contents. The aforementioned challenges can lead to user frustration, premature spoilage or expiration of the contents of the fluid-holding vessel 30, wasted material, and/or lost profits for professionals and do-it-yourselfers alike.

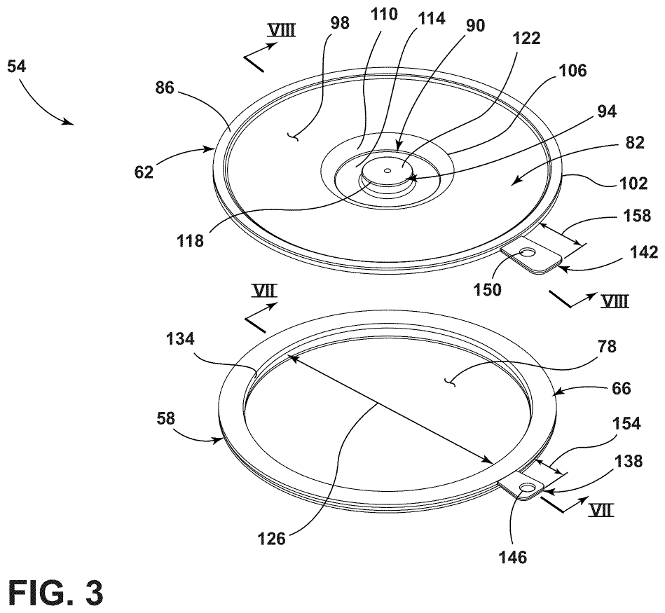

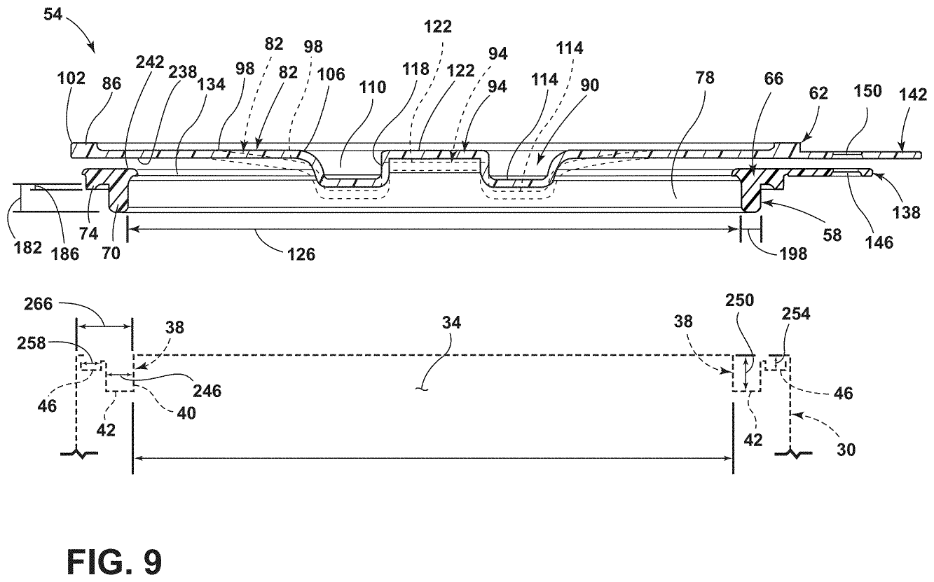

Referring now to FIGS. 3-5, the cover assembly 54 is sized, dimensioned, or otherwise configured to engage with the rim structure 38 of the fluid-holding vessel 30 and cover the opening 34 of the fluid-holding vessel 30. More specifically, as will be discussed in further detail herein, an underside of the first portion 58 of the cover assembly 54 engages with an upper surface of the fluid-holding vessel 30 in a manner that maintains the availability of the opening 34 without the need to remove the first portion 58. For example, a diameter 126 of the aperture 78 of the first portion 58 can be at least about 50% of a diameter 130 of the opening 34 of the fluid-holding vessel 30 (see FIG. 9). In various examples, the diameter 126 of the aperture 78 may be at least about 55% of the diameter 130 of the opening 34, may be at least about 60% of the diameter 130 of the opening 34, may be at least about 65% of the diameter 130 of the opening 34, may be at least about 70% of the diameter 130 of the opening 34, may be at least about 75% of the diameter 130 of the opening 34, may be at least about 80% of the diameter 130 of the opening 34, may be at least about 85% of the diameter 130 of the opening 34, may be at least about 90% of the diameter 130 of the opening 34, may be at least about 95% of the diameter 130 of the opening 34, and/or may be about 100% of the diameter 130 of the opening 34. The first portion 58 may be provided with a ledge 134 that extends radially inward from the tab 70. The ledge 134 may be dimensioned to correspond with the inner surface 40 (see FIGS. 1 and 9) of the rim structure 38 that defines the diameter 130 of the opening 34. Alternatively, the ledge 134 may be dimensioned to extend beyond or within the inner surface 40 of the rim structure 38 that defines the opening 34 such that the ledge 134 overhangs the opening 34 when coupled to the fluid-holding vessel 30. In general, the tab 70, the lip 74, and the ledge 134 of the first portion 58 interact with the fluid-holding vessel 30 in a manner that prevents the fluid that is contained within the fluid-holding vessel 30 from entering the reservoir 42 and/or the channel 46, thereby preventing or minimizing the development of an adhesion force upon coupling the lid 50 to the fluid-holding vessel 30 at a stopping point or conclusion of the task or project.

Referring again to FIGS. 3-5, in examples where the ledge 134 extends radially inward such that the ledge 134 overhangs a portion of the opening 34 when the first portion 58 is coupled to the fluid-holding vessel 30, it is contemplated that an inner diameter of the first portion 58 that defines the diameter 126 of the aperture 78 may be irregular or non-uniform. For example, it is contemplated that the ledge 134 may extend over the opening 34 in some regions about a circumference of the opening 34, while in other regions the ledge 134 may correspond with, or may be flush with, the diameter 130 of the rim structure 38 that defines the opening 34. In such an example, regions where the ledge 134 is flush with the diameter 130 of the rim structure 38 may be employed as a pouring region for the contents of the fluid-holding vessel 30. Regions where the ledge 134 extends over a portion of the opening 34 may be utilized for dragging a fluid-laden portion of a fluid applicator across the ledge 134 to scrape off or generally remove excess fluid.

Referring further to FIGS. 3-5, the second portion 62 can be placed upon the first portion 58 to cover the opening 34 of the fluid-holding vessel 30 when the user has reached a stopping point or conclusion of the task or project being performed. For example, after the user has applied a first coat of paint, the user can place the second portion 62 on top of the first portion 58 and preserve the contents of the fluid-holding vessel 30 until the user decides to apply a second coat of paint, resume the task or project, or otherwise access the contents of the fluid-holding vessel 30. As will be discussed further herein, the second portion 62 is sized and dimensioned to encourage deflection of the second portion 62 into the aperture 78 of the first portion 58. In some examples, to encourage the deflection of the second portion 62, a greater weight or mass may be provided proximate to the central region 106 than that which is present proximate to the perimeter 102. In general, configuring the second portion 62 to encourage deflection of the second portion 62 into the aperture 78 of the first portion 58 can result in at least a portion of a void volume, a headspace, or a gaseous component of the contents of the fluid-holding vessel 30 being encouraged to exit the fluid-holding vessel 30 upon placing the second portion 62 onto the first portion 58. Accordingly, a negative pressure can be established within the fluid-holding vessel 30 when compared to the atmospheric pressure experienced external to the fluid-holding vessel 30. The negative pressure established within the fluid-holding vessel 30 can be established in a passive manner. Said another way, a user can establish the negative pressure within the fluid-holding vessel 30 by placing the second portion 62 upon the first portion 58 when the first portion 58 is coupled to the fluid-holding vessel 30. The weight or mass of the second portion 62 that is located over the center of the opening of the fluid-holding vessel 30 can naturally deflect or sag according to the force of gravity. This sag of the second portion 62 can be further encouraged through the incorporation of the recess 90 and the protrusion 94. These additional features of the second portion 62 provide greater mass at the center of the second portion 62 to enhance the generation of the negative pressure within the fluid-holding vessel 30. The sag of the second portion 62 is depicted, in part, as a phantom line in FIG. 9. The phantom contour of the top surface 98 is representative in nature and does not necessarily indicate a degree or extent of the sag discussed above.

Referring still further to FIGS. 3-5, the first portion 58 may be provided with a lifting handle 138 and/or the second portion 62 may be provided with a grasping handle 142. The lifting handle 138 of the first portion 58 may be utilized by the user to remove the first portion 58 from the fluid-holding vessel 30. Similarly, the grasping handle 142 of the second portion 62 may be utilized by the user to remove the second portion 62 from the first portion 58. The lifting handle 138 may define a hole 146 and the grasping handle 142 may define a hole 150. In various examples, a length 154 of the lifting handle 138 may be less than a length 158 of the grasping handle 142. In such an example, the increased length 158 of the grasping handle 142 of the second portion 62 may facilitate easier removal of the second portion 62 from the first portion 58 when the handles 138, 142 are aligned with one another. Regardless of the lengths of the handles 138, 142, the holes 146, 150 may be positioned along their respective handles 138, 142 such that when the handles 138, 142 are aligned with one another, the holes 146, 150 are also aligned with one another. By aligning the holes 146, 150 with one another regardless of the lengths 154, 158 of the handles 138, 142, it is possible to fasten the first and second portions 58, 62 to one another and/or enable easier display of the cover assembly 54 in a marketplace or store setting.

In examples where the first and second portions 58, 62 are fastened to one another, the fastening may be removable or permanent. For example, the first and second portions 58, 62 may be fastened by riveting, a push snap, a clip, a tie, or any other suitable fastener. In some examples, while the first and second portions 58, 62 may be fastened to one another by way of their holes 146, 150, respectively, the fastening may provide sufficient clearance or “play” to allow lifting or pivoting of the second portion 62 relative to the first portion 58 when coupled to the fluid-holding vessel 30. In various examples, the first and second portions 58, 62 may be coupled to one another along an edge of each of the lifting handle 138 and the grasping handle 142. For example, a living hinge may be provided that couples the first and second portions 58, 62 together.

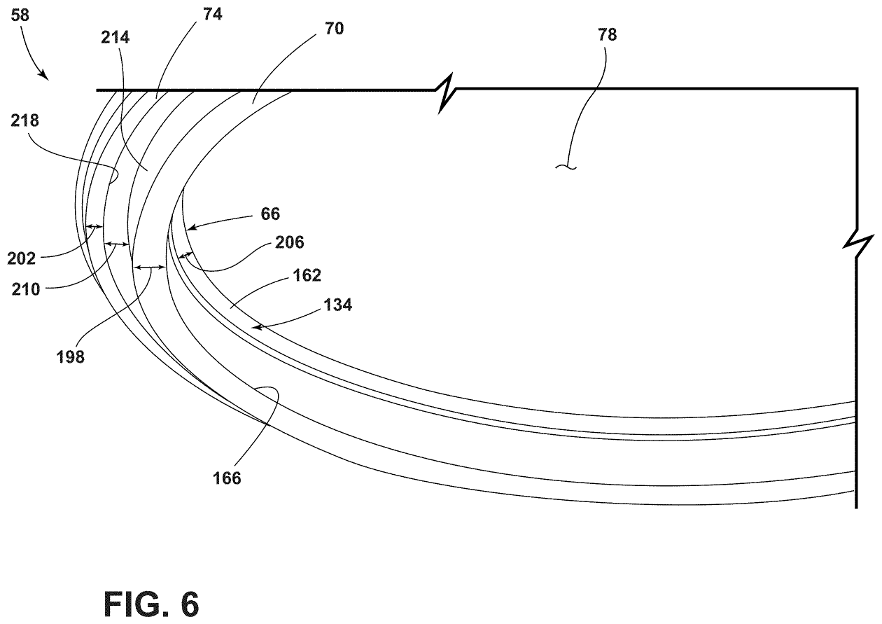

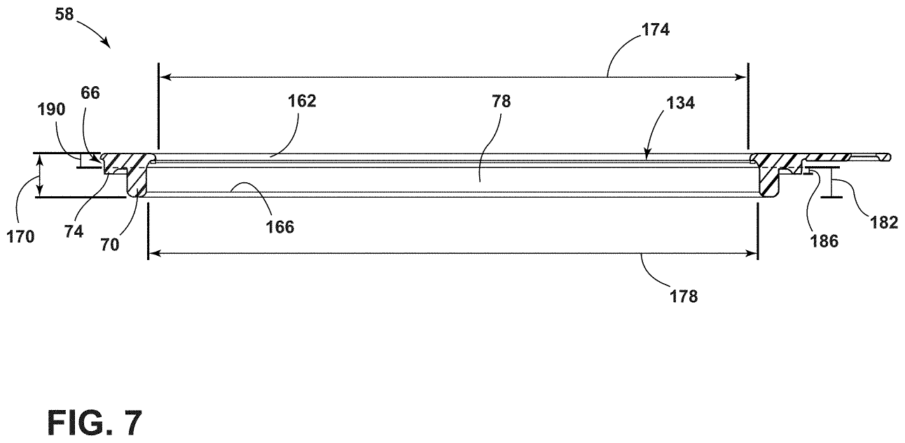

Referring to FIGS. 6 and 7, when the first portion 58 is assembled with the fluid-holding vessel 30, the ledge 134 can define the diameter 130 of the opening 34 that is available for a user to access the contents of the fluid-holding vessel 30. In examples where an interior surface 162 of the ledge 134 and an interior surface 166 of the tab 70 are flush, coplanar, or otherwise aligned with one another, then the diameter 126 of the aperture 78 may be continuous along a height 170 of the first portion 58. However, in examples where the interior surface 162 of the ledge 134 and the interior surface 166 of the tab 70 are not coplanar such that the aperture 78 is provided with a varied diameter 126 as a function of the height 170, then the aperture 78 may be defined by a first diameter 174 that corresponds with the interior surface 162 of the ledge 134 and a second diameter 178 that corresponds with the interior surface 166 of the tab 70. Accordingly, the diameter 126 of the aperture 78 may be non-uniform. While the diameter 126 of the aperture 78 may be non-uniform when the first portion 58 is not coupled to the fluid-holding vessel 30, a percentage of the diameter 130 of the opening 34 that is available upon coupling the first portion 58 to the fluid-holding vessel 30 may be uniform and may be dictated by the lesser of the first diameter 174 and the second diameter 178.

Referring again to FIGS. 6 and 7, a height 182 of the tab 70 may generally correspond with the height 170 of the first portion 58. A height 186 of the lip 74 of the first portion 58 may be less than the height 182 of the tab 70. While the height 182 of the tab 70 may be greater than the height 186 of the lip 74 in various examples, it is contemplated that the heights 182, 186 may be varied relative to one another depending upon dimensions of the reservoir 42 and the channel 46 of the rim structure 38. The planar region 66 is provided with a height 190 from which the height 182 of the tab 70 and the height 186 of the lip 74 may extend. A width 198 of the tab 70, a width 202 of the lip 74, and/or a width 206 of the ledge 134 can be configured to correspond with complementary structures provided on the rim structure 38. Similarly, a distance 210 between an exterior surface 214 of the tab 70 and an interior surface 218 of the lip 74 may correspond with structures defined by the rim structure 38, as will be discussed in further detail herein.

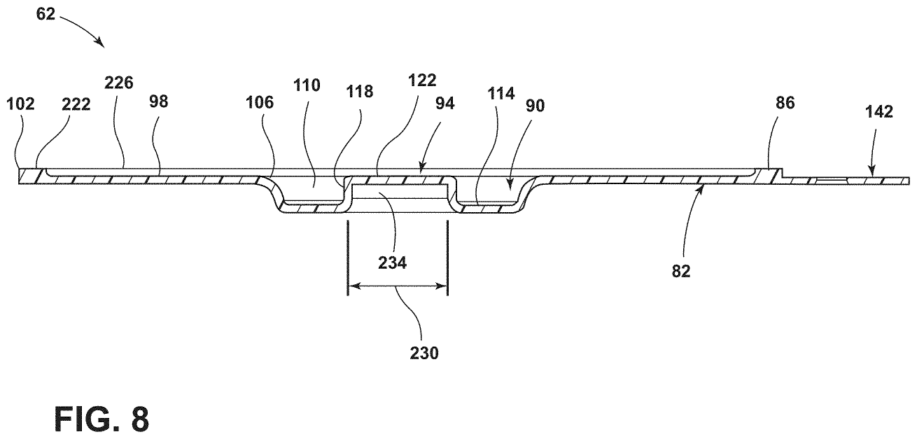

Referring to FIG. 8, the second portion 62 includes the ridge 86. The ridge 86 can be positioned at or proximate to the perimeter 102 of the second portion 62. The ridge 86 extends upwardly from the top surface 98 such that an upper extreme 222 of the ridge 86 is positioned vertically above the top surface 98 of the body 82. Accordingly, the ridge 86 may define a perimeter wall of a basin 226 of the second portion 62. In some examples, the basin 226 may be utilized to receive a bottom or underside of a container (e.g., a second one of the fluid-holding vessel 30) such that the cover assembly 54 can support stacking of one or more containers upon the cover assembly 54. For example, an interior surface of the ridge 86 that defines the perimeter wall of the basin 226 may correspond with an outer diameter of a bottom or an underside of the fluid-holding vessel 30 such that a plurality of the fluid-holding vessel 30 may be stacked upon each other with the cover assembly 54 in place. Accordingly, the second portion 62 of the cover assembly 54 may aid in positioning an additional one of the fluid-holding vessel 30 upon an upper surface of the second portion 62. In alternative examples, the ridge 86 may receive the underside of a second one of the fluid-holding vessel 30 upon the upper extreme 222 of the ridge 86 such that an outer diameter of the fluid-holding vessel 30 is either within a vertical cross-section of the ridge 86 or beyond the ridge 86.

Referring again to FIG. 8, as stated above, the central region 106 of the second portion 62 includes the recess 90, which extends downwardly from the top surface 98 of the body 82. The wall 110 of the recess 90 may be arcuate or radiused. Junctions between the wall 110 and the body 82, as well as between the wall 110 and the bottom surface 114, may each be delineated by an inflection point at these junctions. The inflection points at the junctions between the wall 110 and the body 82, as well as between the wall 110 and the bottom surface 114, can at least partially contribute to the encouragement of the second portion 62 to deflect or deform into the aperture 78 of the first portion 58. The bottom surface 114 of the recess 90 is positioned vertically below the top surface 98 of the body 82. The outer surface 118 of the protrusion 94 is positioned radially inward from the wall 110 and coupled to the wall 110 by the bottom surface 114. The outer surface 118 of the protrusion 94 extends vertically upward from the bottom surface 114 of the recess 90. The outer surface 118 of the protrusion 94 can extend vertically upward from the bottom surface 114 to an extent that corresponds to a height difference between the bottom surface 114 and the top surface 98. Accordingly, in various examples, the upper surface 122 of the protrusion 94 may be coplanar or generally aligned with the top surface 98 of the body 82 of the second portion 62.

Referring further to FIG. 8, in the depicted example, an underside of the protrusion 94 is hollow such that an interior diameter 230 exists between opposing interior surfaces 234 of the protrusion 94. In such an example, a thickness of the body 82, the wall 110, the bottom surface 114, a vertical portion of the protrusion 94 associated with the outer surface 118, and a horizontal portion of the protrusion 94 associated with the upper surface 122 may be equal to one another. In some examples, a thickness of the protrusion 94 may extend from the upper surface 122 to an underside of the bottom surface 114 such that the protrusion 94 is filled-in rather than being hollow. In such an example, the interior diameter 230 may be smaller or may be omitted. The additional material provided to the protrusion 94 in such an example may aid in developing the negative pressure within the fluid-holding vessel 30 upon placing the second portion 62 onto the first portion 58 by providing additional mass or weight at a center point of the second portion 62. While the grasping handle 142 is provided on the second portion 62 in the depicted example, it is contemplated that the protrusion 94 may be utilized as a handle or gripping point by the user to remove the second portion 62 from the first portion 58 and/or to place the second portion 62 upon the first portion 58. Accordingly, in some examples, the grasping handle 142 may be omitted.

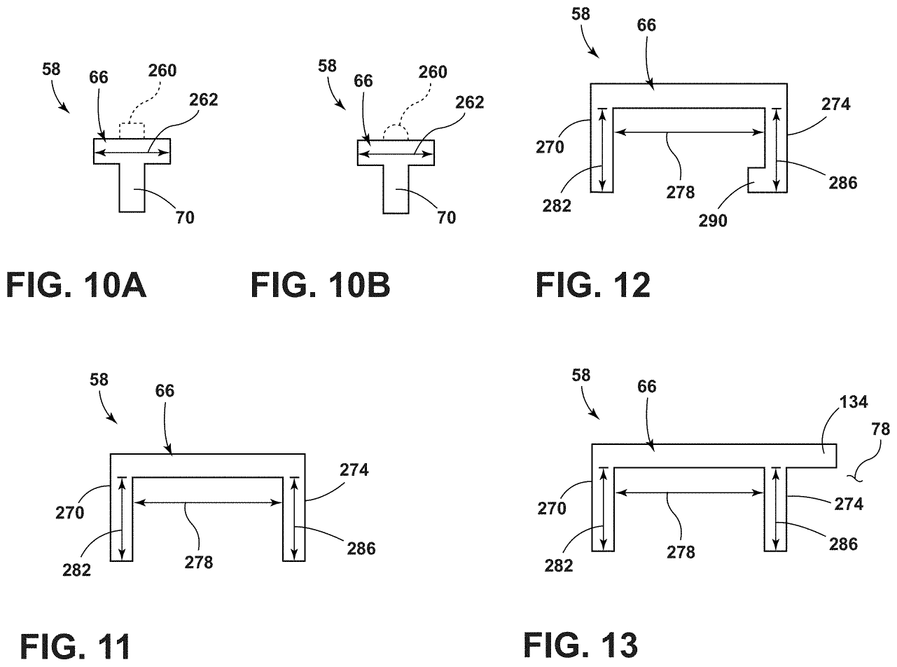

Referring to FIG. 9, the second portion 62 rests upon the first portion 58 when assembled as the cover assembly 54. More specifically, an underside 238 of the second portion 62 engages with an upper surface 242 of the first portion 58. For example, the underside 238 of the second portion 62 in a region of the second portion 62 that corresponds with the body 82 and/or the ridge 86 may contact the upper surface 242 of the first portion 58 in a region of the first portion 58 that corresponds to the planar region 66 and/or the ledge 134. In some examples, the planar region 66 may include a contoured profile that receives the second portion 62. This contoured profile can include any one of various cross-sectional shapes that can include, but are not limited to, an inwardly-sloping profile, an outwardly-sloping profile, a convex profile, a concave profile, a triangular profile, a rectangular profile, and/or any other suitable polygon shape. In various examples, the planar region 66 can be provided with a contoured ring (see FIGS. 10A and 10B) that extends from the upper surface 242 of the first portion 58 (e.g., extends vertically upward or vertically downward from the upper surface 242). For example, the contoured ring may be provided upon the upper surface 242 at a given radial position of the first portion 58 and the contoured ring may have a circular cross-section, a parabolic cross-section, a rectangular cross-section, a triangular cross-section, or any other suitable polygon shape for its cross-section. The contoured ring can define an engagement surface of interaction between the first portion 58 and the second portion 62. Providing the first portion 58 with the contoured ring may enable a greater degree of deflection of the second portion 62 upon placing the second portion 62 on top of the first portion 58. It is contemplated that the greater deflection provided by employing the contoured ring can result from a greater vertical height in some, but not all, of the upper surface 242. Additionally or alternatively, the greater deflection can result from increasing a distance between the center point of the second portion 62 and a point of contact between the first portion 58 and the second portion 62. It is contemplated that employing the contoured ring may establish two points of contact between the first portion 58 and the second portion 62 at a given circumferential position and may therefore provide two opportunities for establishing a seal between the first portion 58 and the second portion 62 at the given position. It is further contemplated that the contoured ring can encourage liquid to flow off of the upper surface 242.

Referring again to FIG. 9, deflection of the second portion 62 relative to the first portion 58 when the first and second portions 58, 62 are engaged with one another can result in an increase in a magnitude of the negative pressure established in the fluid-holding vessel 30 for a given liquid volume contained within the fluid-holding vessel 30 when compared to examples that do not result in deflection of the second portion 62. It is contemplated that even if the second portion 62 did not deflect from a generally planar orientation upon engaging the second portion 62 with the first portion 58, the negative pressure may still be established within the fluid-holding vessel 30 due to the configuration of the central region 106 of the second portion 62. More specifically, the recess 90 positioned proximate to the central region 106, as well as at least a portion of the protrusion 94, extend down within the aperture 78 of the first portion 58 such that at least a volume of gaseous components of the fluid-holding vessel 30 that corresponds with the displacement caused by the structures of the wall 110, the bottom surface 114, and/or the protrusion 94 may be expelled from the fluid-holding vessel 30. It is contemplated that by pressing down upon the upper surface 122 of the protrusion 94, and thereby causing deflection of the second portion 62 relative to the first portion 58 when the first and second portions 58, 62 are engaged with one another, may produce the deflection of the second portion 62 and encourage the establishment of the negative pressure within the fluid-holding vessel 30 in an active manner.

Referring further to FIG. 9, the width 198 of the tab 70 can generally correspond with a width 246 of the reservoir 42. Similarly, the height 182 of the tab 70 can generally correspond with a depth 250 of the reservoir 42. Similar to the dimensional relationship between the tab 70 and the reservoir 42, the height 186 of the lip 74 can generally correspond with a depth 254 of the channel 46. Likewise, a width 202 of the lip 74 can generally correspond with a width 258 of the channel 46. Accordingly, upon coupling the first portion 58 to the rim structure 38 of the fluid-holding vessel 30, a substantial portion of the volume of the reservoir 42 and the channel 46 can be occupied by the tab 70 and the lip 74, respectively. Accordingly, a probability of the contents of the fluid-holding vessel 30 entering into the reservoir 42 and/or the channel 46 during normal use of the fluid-holding vessel 30 can be decreased and, in so doing, decreasing a likelihood of adhesion between the fluid-holding vessel 30 and the lid 50 while also providing a decrease in the likelihood of premature expiration or fouling of the contents of the fluid-holding vessel 30. It is contemplated that the tab 70 and the lip 74 need not occupy an entirety of the reservoir 42 and the channel 46, respectively.

Referring to FIGS. 10A and 10B, an exemplary cross-section of the first portion 58 is shown according to an alternative example. In the depicted example, the lip 74 may be omitted and the first portion 58 can include the planar region 66 and the tab 70. In such an example, the planar region 66 can extend beyond lateral sides of the tab 70 such that the planar region 66 and the tab 70 are in a non-parallel relationship with one another. For example, the planar region 66 may extend in a direction that is perpendicular to the tab 70 such that the cross-section of the first portion 58 is T-shaped. Said another way, the tab 70 can extend downwardly from a bottom surface of the planar region 66. It is contemplated that, as discussed above, the planar region 66 may be provided with a contoured ring 260 that extends upwardly from a top surface of the planar region 66 such that the cross-section of the first portion 58 is generally cross-shaped. In the depicted example, the cross-section shown may be referred to as a radial cross-section as opposed to a diametric cross-section. That is, a single side of the first portion 58 is depicted in cross-section, with the tab 70 being configured to be received within the reservoir 42 of the rim structure 38. Accordingly, the dimensions of the planar region 66 may be such that a width 262 of the planar region 66 corresponds with a width 266 (see FIG. 9) of the rim structure 38.

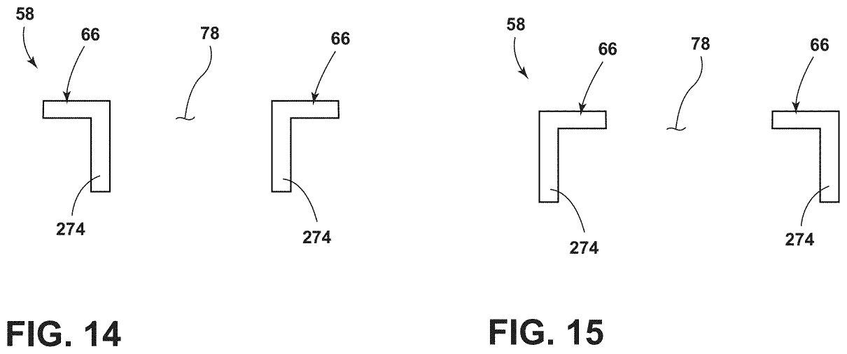

Referring to FIGS. 11-13, additional exemplary cross-sections of the first portion 58 are shown according to alternative examples. In the depicted examples, the tab 70 and the lip 74 are omitted such that the first portion 58 does not substantially enter the volume of the reservoir 42 or the channel 46. Rather, the first portion 58 is provided with a first leg 270 and a second leg 274 that extend downwardly from the bottom surface of the planar region 66. A distance 278 between interior surfaces of the first leg 270 and the second leg 274 can correspond with the width 266 of the rim structure 38. The interior surface of the first leg 270 can engage with an exterior surface of the fluid-holding vessel 30 and/or the rim structure 38. The interior surface of the second leg 274 can engage with the inner surface 40 (see FIGS. 1 and 9) of the rim structure 38. As with the above example discussed with regard to FIGS. 10A and 10B, the cross-sections shown may be referred to as radial cross-sections as opposed to diametric cross-sections. That is, a single side of the first portion 58 is depicted in the cross-sectional schematic representations. A height 282 of the first leg 270 may be varied relative to a height 286 of the second leg 274. In some examples, the first leg 270 may be omitted (see FIG. 14) or the second leg may be omitted (see FIG. 15). In various examples, the second leg 274, which engages with the inner surface 40 of the rim structure 38, can be provided with a lateral arm 290 that extends in a lateral direction that is toward the first leg 270. The lateral arm 290 can engage with an underside of the rim structure 38 to aid in retention of the first portion 58 to the fluid-holding vessel 30. The lateral arm 290 may be beneficial in examples where the tab 70 and/or the lip 74 are omitted. In the example depicted in FIG. 13, the planar region 66 extends between the first and second legs 270, 274 and beyond the second leg 274 toward a center of the aperture 78 of the first portion 58. The portion of the planar region 66 that extends beyond the second leg 274 toward the center of the aperture 78 may define the ledge 134 discussed above.

Referring to FIGS. 14 and 15, exemplary cross-sections of the first portion 58 are shown according to additional examples. The cross-sections shown may be referred to as diametric cross-sections as opposed to the radial cross-sections discussed with regard to FIGS. 10A-13. That is, both sides of the first portion 58 are depicted in the cross-sectional schematic representations. In the example depicted in FIG. 14, the first leg 270 has been omitted. In such an example, the planar region 66 extends over the top of the rim structure 38 to cover the reservoir 42 and the channel 46, while the second leg 274 extends along the inner surface 40 (see FIGS. 1 and 9) of the rim structure 38. In the example depicted in FIG. 15, the second leg 274 has been omitted. In such an example, the planar region 66 extends over the top of the rim structure 38 to cover the reservoir 42 and the channel 46, while the first leg 270 extends downwardly along an exterior surface or outer diameter of the fluid-holding vessel 30.

Referring again to FIGS. 10A-15, while specific schematic representations of the first portion 58 have been discussed with regard to various features, it is within the scope of this disclosure that features may be interchanged between the examples and/or omitted from the examples disclosed herein. The interchangeability and/or adaptability of the cross-section of the first portion 58 is similarly applicable to all of the examples discussed in the entirety of this disclosure.

Modifications of the disclosure will occur to those skilled in the art and to those who make or use the concepts disclosed herein. Therefore, it is understood that the embodiments shown in the drawings and described above are merely for illustrative purposes and not intended to limit the scope of the disclosure, which is defined by the following claims as interpreted according to the principles of patent law, including the doctrine of equivalents.

It will be understood by one having ordinary skill in the art that construction of the described concepts, and other components, is not limited to any specific material. Other exemplary embodiments of the concepts disclosed herein may be formed from a wide variety of materials, unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further, it is to be understood that such concepts are intended to be covered by the following claims, unless these claims, by their language, expressly state otherwise.

What is claimed is:

1. A cover assembly, comprising:
a first portion, wherein the first portion comprises:
a planar region, the planar region defining an aperture; and
a tab extending downwardly from the planar region and configured to be received within a reservoir of a fluid-holding vessel.

2. The cover assembly of claim 1, wherein the planar region extends beyond lateral sides of the tab.

3. The cover assembly of claim 1, wherein the first portion further comprises:
a lip extending downwardly from the planar region, wherein the lip is positioned radially outward from the tab on the planar region.

4. The cover assembly of claim 3, wherein a height of the tab is greater than a height of the lip.

5. The cover assembly of claim 1, wherein the first portion further comprises:
a lifting handle.

6. The cover assembly of claim 1, further comprising:
a second portion, wherein the second portion comprises:
a body comprising a top surface; and
a recess extending downwardly from the top surface of the body proximate to a central region of the second portion such that the recess comprises a wall and a bottom surface.

7. The cover assembly of claim 6, wherein the wall is arcuate in shape.

8. The cover assembly of claim 7, wherein the second portion further comprises:
a ridge extending upward from the top surface and positioned proximate to a perimeter of the second portion.

9. The cover assembly of claim 7, wherein the second portion further comprises:
a protrusion extending upwardly from the bottom surface of the recess such that the protrusion defines an outer surface and an upper surface, wherein the upper surface is coplanar with the top surface of the body.

10. The cover assembly of claim 9, wherein an underside of the protrusion is hollow such that an interior diameter exists between opposing interior surfaces of the protrusion.

11. The cover assembly of claim 6, wherein the second portion further comprises:
a grasping handle.

12. The cover assembly of claim 11, wherein the grasping handle extends from a perimeter of the second portion.

13. The cover assembly of claim 11, wherein the first portion further comprises:
a lifting handle.

14. The cover assembly of claim 13, wherein the lifting handle comprises a first length, and wherein the grasping handle comprises a second length.

15. The cover assembly of claim 14, wherein the first length is less than the second length.

16. The cover assembly of claim 13, wherein the lifting handle defines a first hole.

17. The cover assembly of claim 16, wherein the grasping handle defines a second hole.

18. The cover assembly of claim 17, wherein the first hole and the second hole are positioned along the lifting handle and the grasping handle, respectively, to enable alignment of the first hole and the second hole.

19. The cover assembly of claim 11, wherein the lifting handle and the grasping handle are coupled to one another.

20. The cover assembly of claim 19, wherein the coupling of the lifting handle to the grasping handle defines a living hinge.
